(19) United States
(12) Patent Application Publication
(10) Pub. No.: US 2005/0287373 A1
(43) Pub. Date: Dec. 29, 2005

(54) Papermaking machine belt

(75) Inventors: Atsushi Ishino, Tokyo (JP); Hiroyuki Takamura, Tokyo (JP); Tsutomu Ishii, Tokyo (JP)

Correspondence Address: MORGAN LEWIS & BOCKIUS LLP, 1111 PENNSYLVANIA AVENUE NW, WASHINGTON, DC, 20004, US

(73) Assignee: Ichikawa Co., Ltd.

(21) Appl. No.: 11/165,187

(22) Filed: Jun. 24, 2005

(30) Foreign Application Priority Data
Jun. 25, 2004 (JP) P.2004-188477
Mar. 23, 2005 (JP) P.2005-083478

(51) Int. Cl. C08G 18/10; B32B 27/00

(52) U.S. Cl. 428/423.1

(57) ABSTRACT

A papermaking machine belt has a polyurethane and a substrate. The polyurethane is obtained by curing a mixture of an urethane prepolymer, a curing agent, and a non-reactive liquid poly(dimethyl siloxane) in which an amount ratio thereof with respect to a sum of the amount of the urethane prepolymer and the curing agent is from 0.5 to 25% by weight.

### CROSS-REFERENCE TO RELATED APPLICATIONS

This application is based upon and claims the benefit of priority from the prior Japanese Patent Applications No. 2004-188477 filed on Jun. 25, 2004, and No. 2005-083478 filed on Mar. 23, 2005 the entire contents of which are incorporated herein by reference.

### BACKGROUND OF THE INVENTION

1. Field of the Invention

The present invention relates to a papermaking machine belt (hereinafter, occasionally referred simply to as “belt”). More particularly, the present invention relates to a belt produced from a specific compound as a polyurethane which configures the belt to exhibit excellent crack resistance, abrasion resistance, permanent distortion resistance, and other physical properties.

2. Description of the Related Art

In papermaking plants, a belt having a substrate and a polyurethane is used at various producing steps. In some detail, the belt having the substrate and the polyurethane is used as a shoe press belt or transfer belt at the press part and a soft calender belt at the calender part.

The belt is essentially formed by a belt made of a fabric or the like for establishing the intensity of the entire belt, and a polyurethane laminated on one or both sides of the substrate. Different polyurethanes may be used as the polyurethane depending on the part at which the belt is used and their purposes. In any case, the belt moves at a high speed over rolls under a high pressure developed between the rolls. Thus, the belt is required to have high degree physical properties. In particular, with the recent trend for higher operation speed of papermaking machines accompanying the enhancement of paper productivity and higher pressure at the press portion, the working atmosphere has become severer. Therefore, the belt to be used for these high performance papermaking machines is required to exhibit higher performances as in abrasion resistance, permanent distortion resistance, crack resistance, and compressive fatigue resistance.

In order to produce a polyurethane, a diisocyanate terminated by two isocyanate groups and a polyol terminated by a plurality of hydroxyl groups are subjected to polyaddition reaction to produce an urethane prepolymer terminated by an isocyanate group. The liquid urethane prepolymer thus obtained has a low molecular weight. By heating a mixture of the liquid urethane prepolymer with a curing agent (chain extender), the liquid urethane prepolymer is cured to obtain a solid polymer polyurethane.

Accordingly, the performance of polyurethanes depends on the combination of diisocyanate, polyol, and curing agent. For a papermaking machine belt also, various proposals have been made for selection and combination of these components (see JP-A-11-247086 and JP-A-2004-52204). However, these approaches leave something to be desired in the aforementioned requirements.

JP-A-11-247086 and JP-A-2004-52204 are referred to as a related art.

### SUMMARY OF THE INVENTION

An object of the invention is to provide a papermaking machine belt having better abrasion resistance, permanent distortion resistance, crack resistance, compressive fatigue resistance, and other properties.

The invention provides a papermaking machine belt having a polyurethane and a substrate, wherein the polyurethane is obtained by curing a mixture of an urethane prepolymer, a curing agent, and a non-reactive liquid poly(dimethyl siloxane) in which an amount ratio thereof with respect to a sum of the amount of the urethane prepolymer and the curing agent is from 0.5 to 25% by weight.

Since the polyurethane used for the papermaking machine belt is made from a mixture of an urethane prepolymer, a curing agent, and a non-reactive liquid poly(dimethyl siloxane), the papermaking machine belt is superior in abrasion resistance, permanent distortion resistance, crack resistance, etc.

### BRIEF DESCRIPTION OF THE DRAWINGS

FIG. 1 is a typical sectional view illustrating the configuration of a papermaking machine belt according to the invention;

FIG. 2 is a schematic diagram illustrating a process for the production of a papermaking machine belt according to the invention (spreading step);

FIG. 3 is a schematic diagram illustrating a process for the production of a papermaking machine belt according to the invention (curing step);

FIG. 4 is a schematic diagram illustrating a device for evaluating crack resistance;

FIG. 5 is a schematic diagram illustrating a device for evaluating abrasion resistance; and

FIG. 6 is a schematic view illustrating the constitution of another example of the papermaking machine belt according to the invention on which drainage grooves are formed.

### DETAILED DESCRIPTION OF THE PREFERRED EMBODIMENTS

An embodiment of a papermaking machine belt according to the invention will be described with reference to the drawings.

A polyurethane included in the papermaking machine belt of the embodiment is a cured mixture of an urethane prepolymer, a curing agent, and a non-reactive liquid poly(dimethyl siloxane).

The urethane prepolymer can be prepared by reacting an organic diisocyanate with a polyol by any known method.

Preferred examples of the organic diisocyanate employable herein include paraphenylene diisocyanate (PPDI), tridene diisocyaante (TODI), isophorone diisocyanate (IPDI), 4,4′-methylenebis (phenylisocyanate) (MDI), toluene-2,4-diisocyanate (2, 4-TDI), toluene-2,6-diisocyanate (2,6-TDI), naphthalene-1,5-diisocyanate (NDI), diphenyl-4,4′-diisocyanate, dibenzyl-4,4′-diisocyanate, stilbene-4, 4′-diisocyanate, benzophenone-4,4′-diisocyanate, 1,3-xylenediisocyanate, 1,4-xylenediisocyanate, 1,6-hexamethylenediisocyanate, 1,3-cyclohexyl diisocyanate, 1,4-cyclohexyldiisocyanate (CHDI), three geometrical isomers of 1,1′-methylene-bis(4-isocyanato cyclohexane) (generally abbreviated to “H₁₂MDI”), and mixture thereof.

A high molecular long-chain polyol, e.g., one having a molecular weight (MW) of more than 250 is normally used to form a prepolymer. The high molecular long-chain polyol provides a resin with flexibility and elastomeric properties. A high molecular polyol, typically polyether polyol, polyester polyol or hydrocarbon polyol having a number-average molecular weight of at least 250 is often used to prepare a prepolymer. The molecular weight of the high molecular polyol is preferably from about 500 to 6,000, most preferably from about 650 to 3,000. However, the molecular weight of the high molecular polyol may be about 10,000 at maximum and about 250 at minimum. The high molecular polyol may have low molecular glycols and triols having a molecular weight of from 60 to 250 incorporated therein.

A preferred polyalkylene ether polyol may be represented by the general formula “HO(RO)ₙH” in which “R” represents an alkylene radical, and “n” represents an integer such that the polyether polyol has a number-average molecular weight of at least 250. These polyalkylene ether polyols are well-known polyurethane product components which can be prepared by polymerizing a cyclic ether such as alkylene oxide with glycol, dihydroxyether or the like by a known method. The average number of hydroxyl functional groups is from about 2 to about 8, preferably from about 2 to about 3, more preferably from about 2 to about 2.5.

The polyester polyol is typically prepared by reacting a dibasic acid (which is normally adipic acid but may contain other components such as glutaric acid, succinic acid, azelaic acid, sebacic acid, and phthalic anhydride) with a diol such as ethylene glycol, 1,2-propylene glycol, 1,4-butylene glycol, 1,6-hexylene glycol, diethylene glycol, and polytetramethylene ether glycol. In the case where it is intended to branch the chain or eventually crosslink the chain, a polyol such as glycerol, trimethylol propane, pentaerythritol, and sorbitol may be used. A diester may be used instead of dibasic acid. Some polyester polyols may be produced from caprolactone or dimerized unsaturated aliphatic acid.

The hydrocarbon polyol can be prepared from an ethylenically unsaturated monomer such as ethylene, isobutylene and 1,3-butadiene. Examples of the hydrocarbon polyol employable herein include polybutadiene polyol. Specific examples of the polybutadiene polyol employable herein include “Poly-bdR-45HT” (produced by Atochem Inc.), “DIFOL” (produced by Amoco Corp.), and “Kraton L Polyol” (produced by Shell Chemical Co.).

A polycarbonate polyol, too, may be used. The polycarbonate polyol can be prepared by reacting a glycol (e.g., 1,6-hexylene glycol) with an organic carbonate (e.g., diphenyl carbonate, diethyl carbonate, ethylene carbonate).

The curing agent or chain extender to be used with the prepolymer can be selected from a wide variety of well-known organic diamines or polyol materials of common use. A preferred material is a low melting material which is either solid or liquid. A particularly preferred material is a diamine, polyol or blend thereof having a melting point of less than 140° C. At present, these diamines or polyols are normally used as a polyurethane curing agent in the art. The curing agent is normally selected depending on the required reactivity, properties required for specific purposes, required working conditions, desired pot life, etc. A known catalyst may be used in combination with the curing agent.

As the curing agent there may be used water, aliphatic diol, aromatic diamine, or the like. As the aliphatic diol there is preferably used 1,4-butanediol, 1,3-propanediol, 1,6-hexanediol, or the like. As the aromatic diamine, there is preferably used di(methylthio)-toluenediamine (DMTDA), 3,3′-dichloro-4,4′-diaminodiphenylmethane (MBOCA) or the like. DMTDA and MBOCA are preferred. DMTDA occurs in various isomers having different substitution sites of dimethylthio group and amino group, and may be used in the form of mixture of these isomers. This curing agent is available as “ETHACURE 300” (produced by Albemarle Corporation of USA).

Referring to the mixing ratio of the aforementioned urethane prepolymer and the curing agent, the equivalent ratio of active hydrogen group in the curing agent to isocyanate group in the urethane prepolymer is preferably from 0.9 to 1.10.

The non-reactive liquid poly(dimethyl siloxane) is preferably a polymer compound containing siloxane such as silicone oil, silicone rubber and silicone elastomer. Examples of these silicones include those belonging to silicone fluid series available in the trade name “Silicone Fluids SWS-101” from Wacker Silicones Corporation and “KF96” (produced by Shin-Etsu Chemical Co., Ltd.).

The viscosity (employed as a measure of chain length herein) of the aforementioned non-reactive liquid poly(dimethyl siloxane) may be arbitrary so far as it has an effect of improving the abrasion resistance of the resulting product without drastically impairing the abrasion properties thereof. Accordingly, the viscosity of the non-reactive liquid poly(dimethyl siloxane) may be 200,000 cst or higher but is preferably from 5,000 to 100,000 cst.

The non-reactive liquid poly(dimethyl siloxane) is used in an amount of from 0.5 to 25% by weight based on the sum of the amount of the urethane prepolymer and the curing agent.

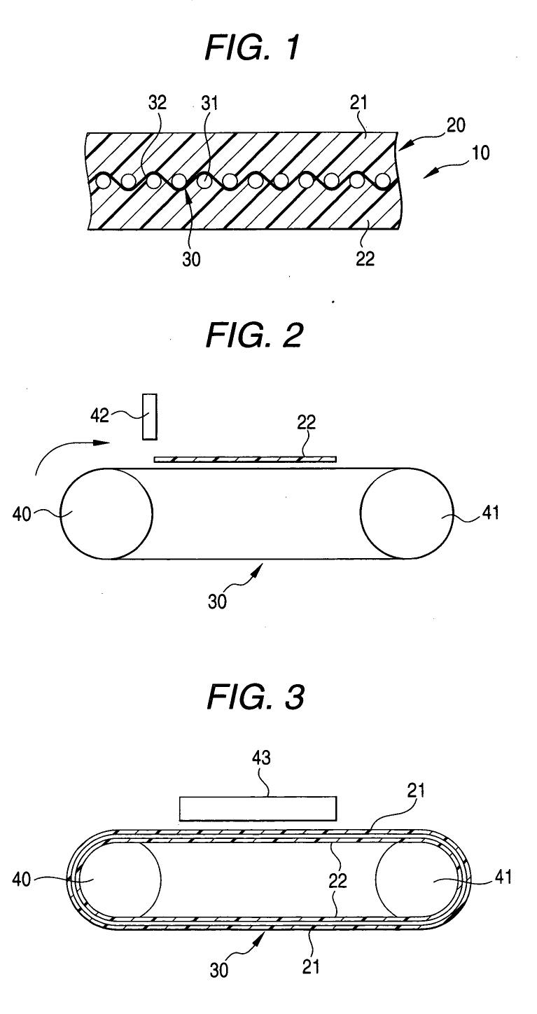

In order to prepare the papermaking machine belt, a substrate such as fabric impregnated with a mixture of the aforementioned urethane prepolymer, curing agent and non-reactive liquid poly(dimethyl siloxane) is heated to cure the mixture. As a result, a belt 10 having a polyurethane 20 (felt side resin 21 and shoe side resin 22) laminated on the both sides of a substrate 30 as shown in FIG. 1 is prepared. As the substrate 30 there may be used one obtained by laminating yarns 31 and 32 on each other or one obtained by spirally winding a film, a knit or a band-shaped material having a narrow width besides a fabric obtained by weaving a yarn 31 in MD direction and a yarn 32 CMD direction as shown.

In order to laminate a polyurethane on the both sides of the substrate 30, the aforementioned mixture is supplied through a resin coating nozzle 42 onto the substrate 30 extending between rolls 40, 41 which are being rotated as shown in FIG. 2. The coated substrate 30 is then dried for solidification. Thereafter, though not shown, the. substrate 30 is turned over. The aforementioned mixture is supplied onto the substrate 30, and then dried for solidification. Subsequently, as shown in FIG. 3, the substrate 30 is heated by a heat source 43 to cure the mixture spread over the both sides thereof. Subsequently, the belt is polished on the both sides thereof to a desired thickness to obtain the desired papermaking machine belt.

The heating temperature at which curing occurs is normally from 20° C. to 150° C., preferably from 90° C. to 140° C. The substrate is preferably heated for at least 30 minutes so that the mixture is thoroughly cured.

It is preferred that the papermaking machine belt of the embodiment has a constitution in which drainage grooves 4 are formed on the surface of the felt-side resin 21 (outer peripheral surface of the belt). The papermaking machine belt having such a constitution is shown in FIG. 6. The shape of the drainage grooves is not limited to the shape shown in FIG. 6, and as other shapes of the drainage grooves, there can be appropriately employed one in which groove side walls are curved, one in which they are expanded outward, one in which groove bottoms are flat and edges thereof are curved, one in which groove bottoms are round, and the like, as shown in papermaking machine belts described in U.S. Pat. No. 6,296,738B and Japanese Utility Model No. 3,104,830.

### EXAMPLE

The invention will be further described in the following examples, but the invention should not be construed as being limited thereto.

### Examples 1 to 12 and Comparative Examples 1 to 3

As a commercially available polyurethane prepolymer there was prepared TDI (tolylene diisocyanate) or MDI (diphenylmethane diisocyanate) (both TDI and MDI are made of a polytetramethylene ether glycol). As a curing agent there was prepared a commercially available DMTDA (di(methylthio)-toluenediamine) or MBOCA (3,3′-dichloro-4,4′-diaminodiphenylmethane). The urethane prepolymer and the curing agent are mixed at a ratio such that the equivalent ratio of the active hydrogen group in the curing agent to the isocyanate group in the urethane prepolymer is as set forth in Table 1. As a non-reactive liquid poly(dimethyl siloxane) there was prepared “KF96H-30000 (viscosity: about 30,000 cst)” (produced by Shin-Etsu Chemical Co., Ltd.).

The aforementioned various components were mixed in combinations as set forth in Table 1 at ratios as set forth in Table 1 to prepare initial mixtures. During this procedure, the non-reactive liquid poly(dimethyl siloxane) was added before the mixing of the urethane prepolymer with the curing agent. Thereafter, all the components were mixed to obtain initial mixtures.

Subsequently, the substrate 30 was extended between the rolls 40, 41 as shown in FIG. 2. The initial mixture 22 thus prepared was then spread and dried over the substrate 30 while the rolls were being rotated. The substrate 30 was then turned over. The initial mixture 22 thus prepared was then spread and dried over the substrate. Subsequently, as shown in FIG. 3 using the heat source 43, the substrate 30 was heated to 100° C. for 3 hours and then to 130° C. for 5 hours to cure the initial mixture 22. After curing, the surface of the belt is polished, and further, rectangular grooves as drainage grooves having the dimension of 1 mm in width and 1 mm in depth at a pitch of 2.5 mm are cut on the outer peripheral surface thereof, i.e., on the felt-side resin 21, to obtain a belt sample having a belt thickness of 5 mm and having the polyurethane and the substrate.

The belt sample thus obtained was then measured for physical properties. The measurement of the physical properties were conducted as follows.

(1) Crack Resistance

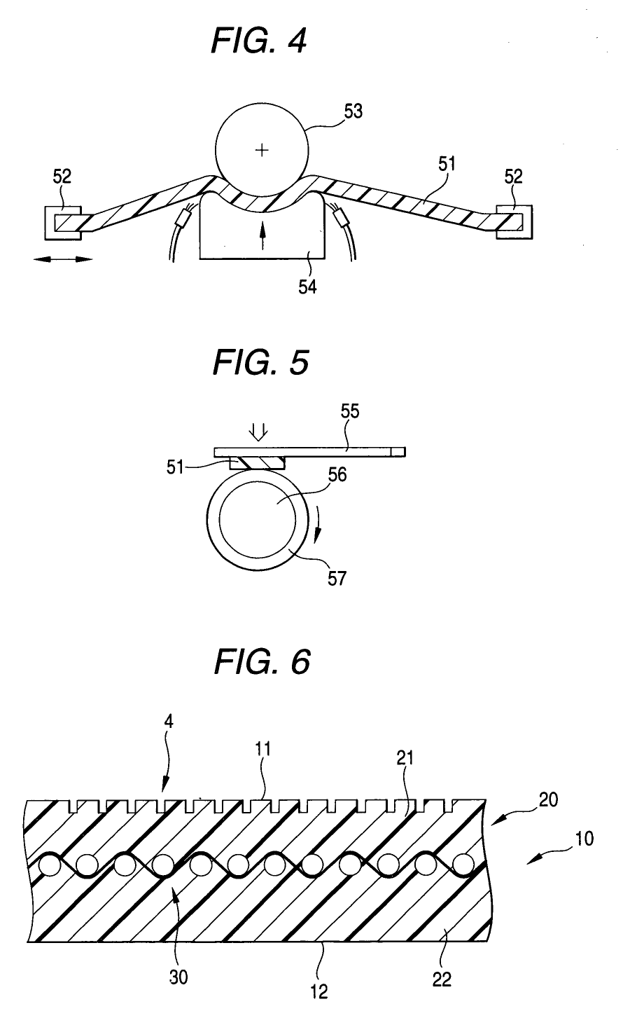

Using a device shown in FIG. 4, the belt sample 51 was grasped at both ends thereof by clamp hands 52, 52. The belt sample 51 was moved back and forth in the horizontal direction as viewed on the drawing with the clamp hands 52, 52 being interlocked. The tension applied to the belt sample 51 was 3 kg/cm and the reciprocating speed was 40 cm/sec. Further, the belt sample 51 was clamped between a rotary roll 53 and a press shoe 54. Under these conditions, the belt sample 51 was pressed at 36 kg/cm² by moving the press shoe 54 toward the rotary roll 53. During the reciprocation, water was sprayed onto the belt sample 51 from the press shoe side to suppress heat generation. The number of reciprocations required until the belt sample 51 undergoes cracking on the side thereof opposed to the rotary roll during reciprocation was then measured. The results are set forth in Table 1.

(2) Abrasion Resistance

The device shown in FIG. 5 was used. The belt sample 51 was attached to the lower portion of a press board 55. A rotary roll 56 having a friction element 57 provided on the periphery thereof was rotated while being pressed against the lower surface (surface to be measured) of the belt sample 51. During this procedure, the pressure developed by the rotary roll 56 was 3 kg/cm and the rotary roll 56 was rotated at a speed of 100 m/min. for 10 minutes. After rotation, the reduction of the thickness of the belt sample 51 was then measured. The results are set forth in Table 1.

TABLE 1

| | Initial mixture | | | | Physical properties of belt | | |
|---|---|---|---|---|---|---|---|
| | | | Equivalent | Added amount of | Number of | | |
| | | | ratio of | poly(dimethyl siloxane) | reciprocations until | Abrasion | |
| | | | A to B | (C) [C/(A + B)] | occurrence of | resistance | General |
| | A | B | [NH₂/NCO] | (wt-%) | cracking (×10,000) | (mm) | evaluation |
| Example 1 | TDI | DMTDA | 0.98 | 1 | 20 to 25 | 0.40 | Slightly good |
| Example 2 | TDI | DMTDA | 0.98 | 3 | >30 | 0.35 | Good |
| Example 3 | TDI | DMTDA | 0.98 | 5 | >30 | 0.1 | Excellent |
| Example 4 | TDI | DMTDA | 0.98 | 10 | 20 to 25 | 0.05> | Good |
| Example 5 | TDI | DMTDA | 0.98 | 20 | 15 to 20 | 0.25 | Slightly good |
| Comparative | TDI | DMTDA | 0.98 | 0 | 15 to 20 | 0.55 | |
| Example 1 | | | | | | | |
| Example 6 | TDI | DMTDA | 0.95 | 5 | 25 to 30 | 0.05> | Excellent |
| Example 7 | TDI | DMTDA | 1.05 | 7 | >30 | 0.15> | Good |
| Example 8 | TDI | MBOCA | 0.99 | 3 | 15 to 20 | 0.25 | Slightly good |
| Example 9 | TDI | MBOCA | 0.99 | 5 | 25 to 30 | 0.1 | Excellent |
| Comparative | TDI | MBOCA | 0.98 | 0 | 10 to 15 | 0.45 | |
| Example 2 | | | | | | | |
| Example 10 | MDI | DMTDA | 0.99 | 3 | 25 to 30 | 0.40 | Good |
| Example 11 | MDI | DMTDA | 0.99 | 5 | >30 | 0.20 | Excellent |
| Example 12 | MDI | DMTDA | 0.99 | 10 | 15 to 20 | 0.05> | Good |
| Comparative | MDI | DMTDA | 0.98 | 0 | 15 to 20 | 0.65 | |
| Example 3 | | | | | | | |

As can be seen in the results of Table 1, the belt samples having a polyurethane prepolymer, a curing agent and a non-reactive poly(dimethyl siloxane) exhibit good crack resistance and abrasion resistance and are remarkably excellent in abrasion resistance in particular as compared with those free of non-reactive liquid poly(dimethyl siloxane) according to the related art process.

In accordance with the embodiment, the papermaking machine belt is superior in crack resistance, abrasion resistance, permanent distortion resistance, etc. and exhibits a raised durability. The use of the papermaking machine belt of the invention can be thus expected to enhance the productivity at the papermaking step, raising the product quality and reducing the cost.

1. A papermaking machine belt, comprising:
a polyurethane; and
a substrate,
wherein the polyurethane is obtained by curing a mixture of an urethane prepolymer, a curing agent, and a non-reactive liquid poly(dimethyl siloxane) in which an amount ratio thereof with respect to a sum of the amount of the urethane prepolymer and the curing agent is from 0.5 to 25% by weight.

2. The papermaking machine belt according to claim 1, wherein the curing agent is di(methylthio)-toluenediamine (DMTDA) or methylenebis(ortho-chloroaniline) (MBOCA).
